(19) United States
(12) Patent Application Publication
(10) Pub. No.: US 2009/0260523 A1
(43) Pub. Date: Oct. 22, 2009

(54) BLENDER

(76) Inventor: Zheng Peng, Ypsilanti, MI (US)

Correspondence Address: ZHAOXIA XU, 4694 SYCAMORE DR., YPSILANTI, MI, 48197, US

(21) Appl. No.: 12/104,633

(22) Filed: Apr. 17, 2008

(51) Int. Cl. A47J 43/07; A47J 43/046; A47J 27/00; B01F 15/06

(52) U.S. Cl. 99/348; 366/146; 241/65

(57) ABSTRACT

A blender (100). Blender (100) comprises a jar (102) having an open top and an open bottom for holding food, a top cap (104) for closing the open top of jar (102), a heated bottom (106) sealingly engaged with the lower end of jar (102) for forming a cooking chamber (107), blending or stirring device (114) installed inside cooking chamber (107) for blending/stirring food, a heating tube (116) fixedly installed on the bottom of heated bottom (106) for heating food, a blender base (112) disposed underneath cooking chamber (107) for supporting cooking chamber (107), a motor (124) installed inside blender base (112) and removably coupled with device (114) for driving device (114) to blend or to stir food, a jar base (110) engaged with the lower portion of jar (102) for adapting cooking chamber (107) to stand on blender base (112), and an in-position detector (128) installed inside blender base (112) for user safety protection.

### TECHNICAL FIELD AND INDUSTRIAL APPLICABILITY OF THE INVENTION

This invention generally relates to blenders. More specifically, this invention relates to a blender that combines heating and blending for making healthy foods, cold and/or hot, for children and adults, as well.

### BACKGROUND OF THE INVENTION

Traditional blenders include a jar for holding food, a blade device installed inside the jar for blending food, and a motor installed inside a base for driving the blade device. People use blenders for blending various foods, such as vegetables, fruits, or for making cold drinks, such as smoothies. Blenders are primarily used as a food-processing device for cold food.

However, many foods need to be heated after being blended, or need to be blended after being heated. Market investigation indicates that consumers desire a blender that can be used for heating food, as well, in addition to for blending food, or for making hot foods, such as sauces, soups, gravies, chocolate fondues, etc.

Sometimes, people use a blender to blend food after the food has been cooked, to make hot creamy food. This two-step process involves labor and skills. It is inconvenient to handle, and, sometimes, potentially unsafe to operate.

Blenders currently on the market are inconvenient for handling and for cleaning after use. Adding a heated bottom onto a regular blender would make the situation even worse, because food tend to be burned on the hot surface, especially when the food has been blended. In order for a heated blender to be easy for cleaning after use, it is desirable that the jar and the heated bottom are separable, or detachable. In this case, the safety of using the heated blender becomes a primary issue, because when the jar is removable, the blade device and the heated bottom would be directly exposed; which may cause significant injuries to its user, if, all of a sudden, the blade device starts to rotate, or the heated bottom starts to heat, due to an accidental wrong input by the user.

Therefore, it remains desirable to provide a blender that combines blending and heating for making healthy foods, cold and/or hot, for children and adults, as well, that is convenient for cleaning after use, and that is safe to operate.

### BRIEF SUMMARY OF THE INVENTION

Accordingly, the present invention is a blender. This blender comprises a jar having an open top and an open bottom for holding food, a top cap for closing the open top of the jar, a heated bottom sealingly engaged with the lower end of the jar for forming a cooking chamber, blade or stirrer means installed inside the cooking chamber for blending or stirring food, an electrical heating tube fixedly installed on the bottom of the heated bottom for heating food, a blender base disposed underneath the cooking chamber for supporting the cooking chamber, a motor installed inside the blender base and operatively coupled with the blade means for driving the blade means, a jar base removably engaged with the lower portion of the jar for adapting the cooking chamber to removably stand on the blender base, and a safety device for user safety protection.

Accordingly, the followings are some of the objects, features, and advantages of the present invention.

It is an object of the present invention to provide a blender that combines heating and blending into one single appliance for making healthy foods, cold and/or hot, for children and adults, as well.

It is a feature of the present invention that this blender includes a jar having a tubular configuration, which is highly convenient for cleaning after use and dishwasher safe. The lower portion of the jar is engaged with a jar base by means of threading, such that the jar can be removed from the jar base for cleaning after use.

It is another feature of the present invention that this blender includes a safety device for user safety protection. Only when the jar has been properly installed on the jar base, can the motor and the heater be activated.

It is an advantage of the present invention that this blender can be used for making many healthy foods, cold and/or hot, such as, smoothies, creamy soups, sauces, gravies, dips, etc., for children and for adults, as well. It is highly convenient for cleaning after use and it is safe to operate.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present invention, a blender 100.

FIG. 2 illustrates an exploded cross-sectional view of heated bottom 106, of an alternative design.

FIG. 3 illustrates an exploded cross-sectional view of seal device 130 and coupling device 132.

FIG. 4 illustrates a bottom view of heated bottom 106.

FIG. 5 illustrates a top view of blender base 112.

FIG. 6 illustrates another cross-sectional view of blender 100.

### DETAILED DESCRIPTION OF THE INVENTION

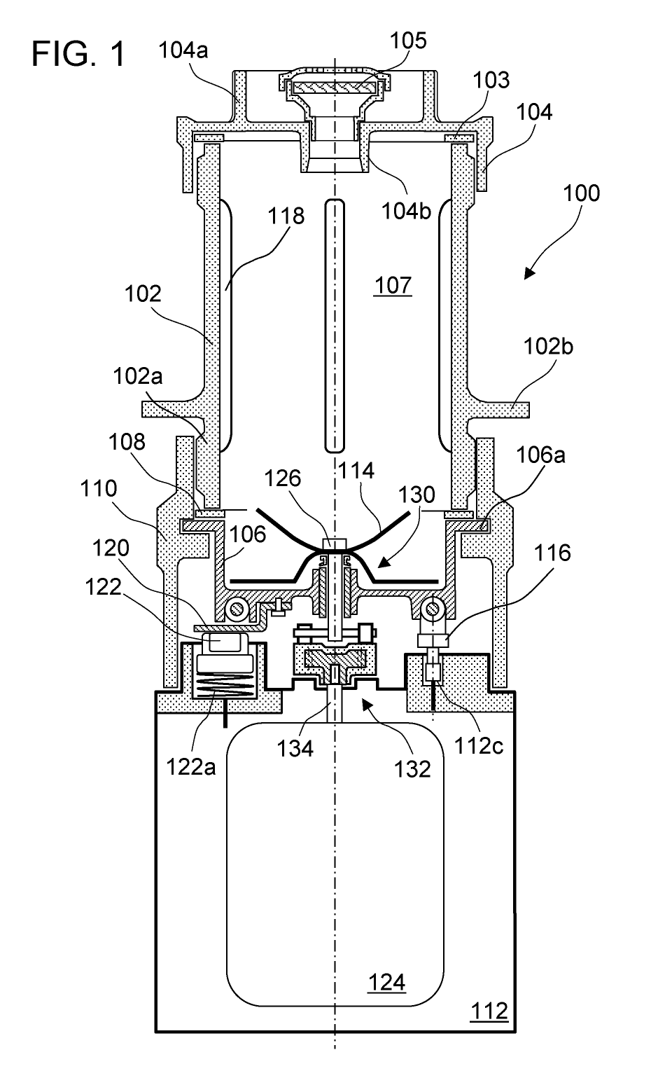

Reference is made to FIG. 1, which illustrates a cross-sectional view of an embodiment of the present invention, a blender 100.

Jar 102, having an open top and an open bottom, is provided for holding food. Jar 102 has a generally tubular configuration and is preferably made from a transparent material. Threading 102a is provided at both ends of jar 102 for engaging with other components. Other jar configurations are readily applicable, as known to those skilled in the art and suggested by this invention disclosure.

A top cap 104 is provided for closing up the open top of jar 102. Cap 104 engages with the upper portion of jar 102 by means of threading 102a for preventing cap 104 from dropping-off and for preventing food from splashing during the blending of food. Threading 102a can be a continuous one-piece thread, or segmented multiple pieces, or event a single small piece. A seal ring 103 is provided in between the upper end of jar 102 and the top of cap 104. As cap 104 is tightened onto jar 102, seal ring 103 is squeezed to generate a seal thereof.

A cylindrical wall 104a, emanating from the top of cap 104 upward to a predetermined distance, is provided for use of handling cap 104. A cylindrical inner wall 104b, emanating from the inside of cap 104 downward to a predetermined distance, is provided for diverting food downward to reduce food throw-out while food is being blended or stirred.

A venting device 105, installed on top of cap 104, is provided for venting steam generated during cooking. Venting device 105 may include filter means for filtering the vented steam, or for minimizing food throw-out.

A heated bottom 106, sealingly engaged with the lower end of jar 102, is provided for closing up the open bottom of jar 102 to form a cooking chamber 107. Heated bottom 106 has a, generally, cup-shaped configuration with the open side facing upward. A flat flange 106a is integrally formed around the open periphery for engaging jar 102. Heated bottom 106 is preferably made from a metal material of high thermal conductivity. Heated bottom 106 can be an integrally die-cast one-piece component or a multiple-piece assembly, e.g., a stainless main body with a clad aluminum plate having a heating tube welded on the bottom. Other configurations for heated bottom 106 are readily applicable to fulfill its functionality, for examples, a flat one or a reverse cup-shaped one, as known to those skilled in the art and suggested by this invention disclosure.

A sealing ring 108 is provided in between the lower end of jar 102 and flange 106a for sealing off the interface thereof. As jar 102 is tightened toward heated bottom 106, sealing ring 108 is squeezed to generate a seal thereof.

Ajar base 110, having a, generally, hollow cylindrical configuration, is provided for supporting cooking chamber 107. The upper end of jar base 110 is engaged with the lower portion of jar 102 by means of threading 102a and the lower end of jar base 110 is extended downward to a predetermined distance, such that cooking chamber 107 is adapted to stand on a blender base 112 for blending or cooking food or on a horizontal countertop or dinning table for serving food. Heated bottom 106 is supported inside jar base 110, fixedly or removably, around flange 106a.

Jar base 110 is provided also for enclosing the space underneath the bottom of heated bottom 106 into a protected area for safety considerations. Some windows or slots (not shown) may be opened on jar base 110 for venting heat, etc.

A blending/stirring device 114, extended into cooking chamber 107, is provided for blending or stirring food disposed inside cooking chamber 107. Device 114 is adapted to rotate at high speeds, e.g., over 8,000 rpm, for blending food. When rotating at lower speeds, e.g., below 2,000 rpm, device 114 serves as a stirrer for generating food movement within cooking chamber 107 to facilitate heat transfer and uniform heating of food. At least one cutting blade conforming the bottom of heated bottom 106 is highly preferred for reducing food deposit on the bottom when food is heated. When stirring food, device 114 is adapted to work intermittently, e.g., to work 1 second for every 10-30 seconds, to minimize the working load of the motor.

An electrical heating tube 116, having a, generally, circular configuration, is provided for heating food disposed inside cooking chamber 107. Heating tube 116 is fixedly installed on the outside surface of the bottom of heated bottom 106, inserted into a groove formed on the bottom, or directly welded on, or integrally cast-in, and disposed substantially close to the periphery of the bottom. The two electrical terminals of heating tube 116 extend downward to a predetermined distance and are adapted to removably engage with an electrical power supply, as cooking chamber 107 is installed in position on blender base 112. Heating tube 116 can be operatively connected with the electrical power supply disposed inside blender base 112 also by means of an electrical connector, as known to those skilled in the art and suggested by this invention disclosure.

There are significant advantages of installing heating tube 116 directly on the bottom of cooking chamber 107. These advantages include saving a significant amount of material for building a full heater that has a thermal diffusion plate, resulting in space and cost saving and higher heat transfer efficiency, etc.

A plurality of co-rotation prevention members 118 is integrally constructed inside jar 102, on the sidewall, for preventing food pieces from co-rotating with device 114, as device 114 rotates. Members 118 include an elongated member, preferably, rib-shaped, that extends generally vertical along the sidewall of jar 102. The upper ends of members 118 extend to the upper portion of jar 102. Members 118 protrude inward to a predetermined distance, away from the sidewall of jar 102. Member 118 acts as a deflector for deflecting liquid flow directions for facilitating blending of food when blender 100 is used for blending food.

A thermo plate 120, made from a metal material of high thermal conductivity, is fixedly installed on the bottom of heated bottom 106, at a location substantially close to heating tube 116, for removably engaging with a thermostat 122. Thermostat 122 is installed on top of blender base 112 and is engaged with thermo plate 120 for detecting the temperature of the bottom of heated bottom 106, as cooking chamber 107 is installed in position on blender base 112. Such temperature is used to control the electrical power to heating tube 116. The upper end of thermostat 122 protrudes upward above the upper surface of blender base 112 with pre-loading, e.g., biased via a spring member 122a. Thermostat 122 can be, alternatively, installed on a bracket that is biased by spring member 122a.

Thermostat 122 can be a digital sensor, such as a NTC or PTC, or an adjustable thermostat, or simply a temperature switch, as known to those skilled in the art and suggested by this invention disclosure.

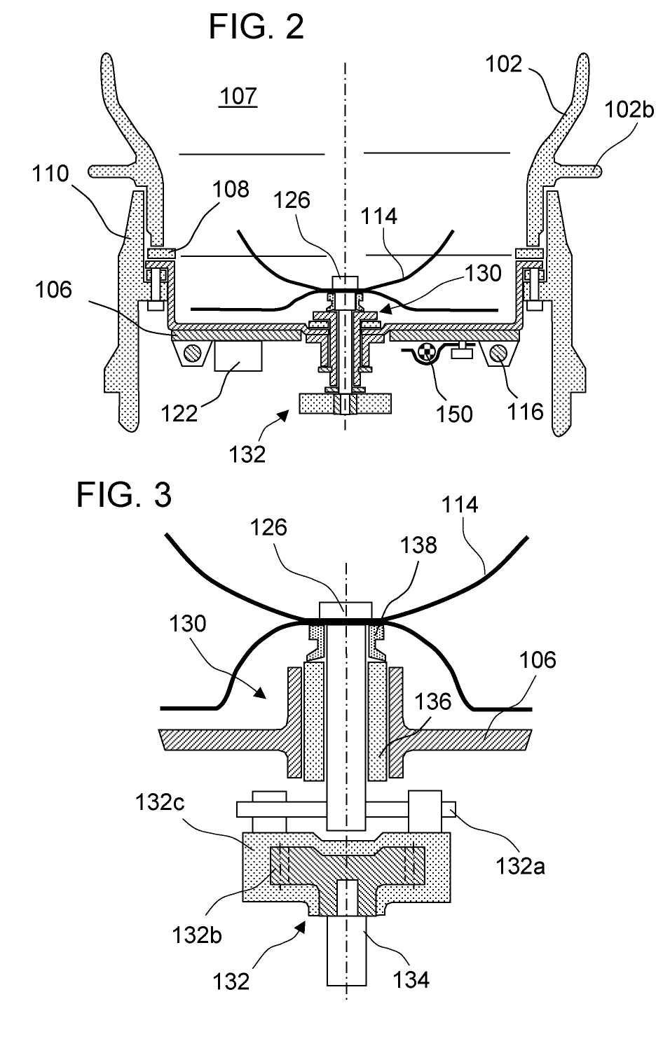

Thermostat 122 can also be fixedly installed on the bottom of heated bottom 106, disposed at a location close to heating tube 116, as illustrated in FIG. 2, which depicts an exploded cross-sectional view of heated bottom 106, of an alternative design. In this case, heated bottom 106 comprises of a stainless main body and a clad aluminum plate, onto which heating tube 116 is welded. Heated bottom 106 is fixedly installed inside jar base 110 by means of a plurality of screws.

A thermal fuse 150 is directly installed on the bottom of heated bottom 106 by means of a clamp for preventing hazardous situation of excessive abnormal temperature rising of heated bottom 106 due to malfunction of blender 100. When such situation accidentally develops, fuse 150 will burn out to shut off the electrical power to heating tube 116.

Reference is made to FIG. 1, again. Blender base 112, disposed underneath cooking chamber 107, is provided for supporting cooking chamber 107. The upper portion of blender base 112 is removably engaged with the periphery of the lower portion of jar base 110 for lockably holding cooking chamber 107 in position.

A motor 124 is installed inside blender base 112 for providing rotation power to device 114. Motor 124 is removablely coupled with the lower end of a drive shaft 126, as cooking chamber 107 is installed in position on blender base 112, and the upper end of shaft 126 is engaged with device 114.

FIG. 3 illustrates an exploded cross-sectional view of a seal device 130 and a coupling device 132.

Seal device 130, provided for sealing off the interface between shaft 126 and the bottom of heated bottom 106, comprises a bushing member 136 and a seal ring 138.

Bushing 136 is co-axial to shaft 126 and is fixedly and sealingly engaged with the bottom of heated bottom 106. Ring 138 is installed on drive shaft 126 and disposed in between device 114 and bushing 136. Ring 138 is adapted to be sealingly engaged with shaft 126 and bushing 136 to seal off the interface thereof. The clearance between bushing 136 and shaft 126 is minimized for ideal sealing performance. However, shaft 126 should be able to rotate with minimal friction resistance, which requires high precision of the fitting surfaces thereof.

Materials for ring 138 are extremely important when selecting the proper seal for an application. Basic requirements include heat resistance, abrasion resistance, elasticity, etc.

Coupling device 132 includes an upper coupling element 132a, which is engaged with the lower end of shaft 126, and a lower coupling element 132b, which is engaged with a motor shaft 134. A thermal insulation material 132c is provided in between element 132a and element 132b for preventing heat from being transferred from element 132a to motor shaft 134 through coupling device 132, such that heat transferred from the bottom of heated bottom 106 is prevented from passing through to motor 124 through motor shaft 134.

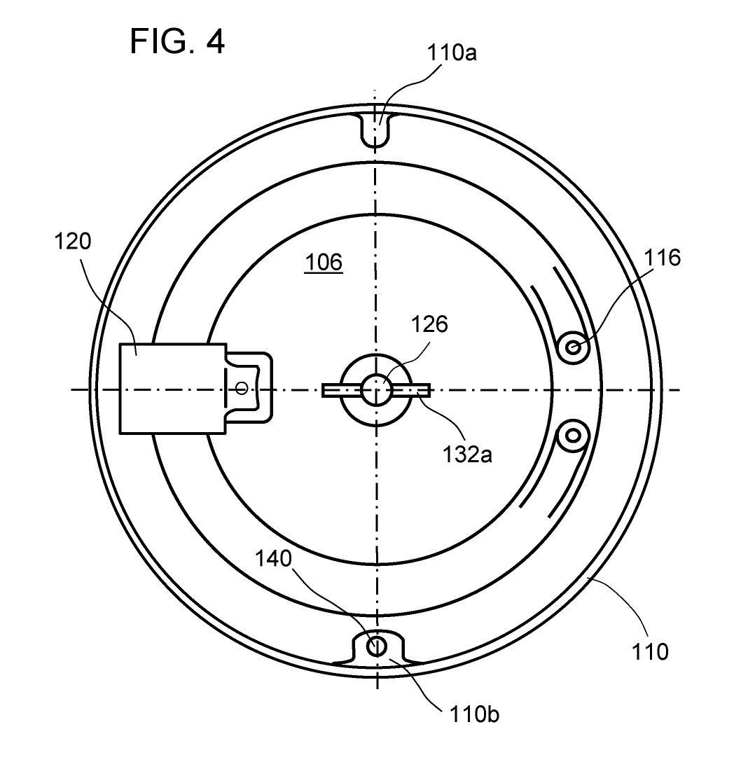

FIG. 4 illustrates a bottom view of heated bottom 106 to depict the general layout of various components disposed on the bottom. Two position guides, generally designated as 110a and 110b, protrude inward a predetermined distance from the inner surface of jar base 110 for guiding cooking chamber 107 in position on blender base 112.

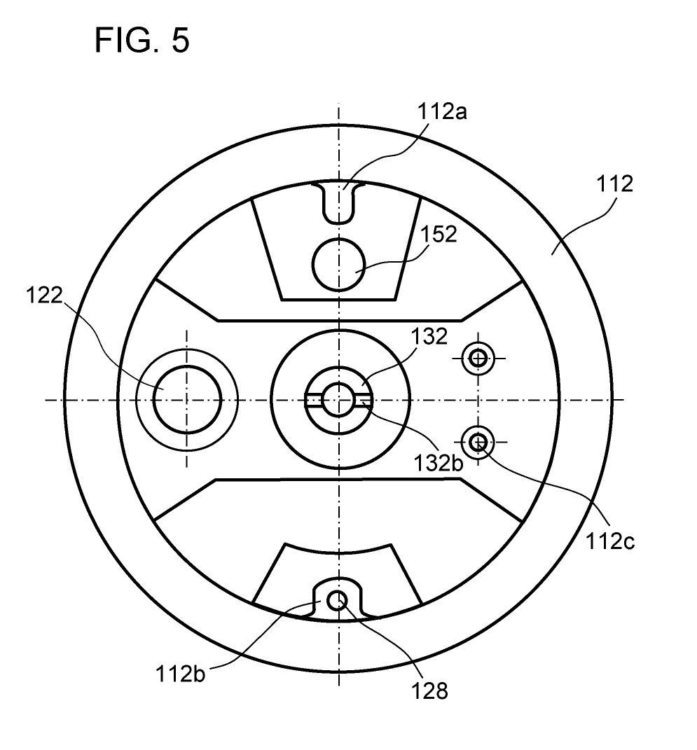

FIG. 5 illustrates a top view of blender base 112 to depict the general layout of various components disposed on the top of blender base 112. Two base guides, generally designated as 112a and 112b, are provided for removably receiving position guides 110a and 110b, respectively. Electrical port 112c is provided on top of blender base 112 for removably receiving the electrical terminals from heating tube 116, such that electrical power from blender base 112 is provided to heating tube 116, as cooking chamber 107 is installed in position on blender base 112.

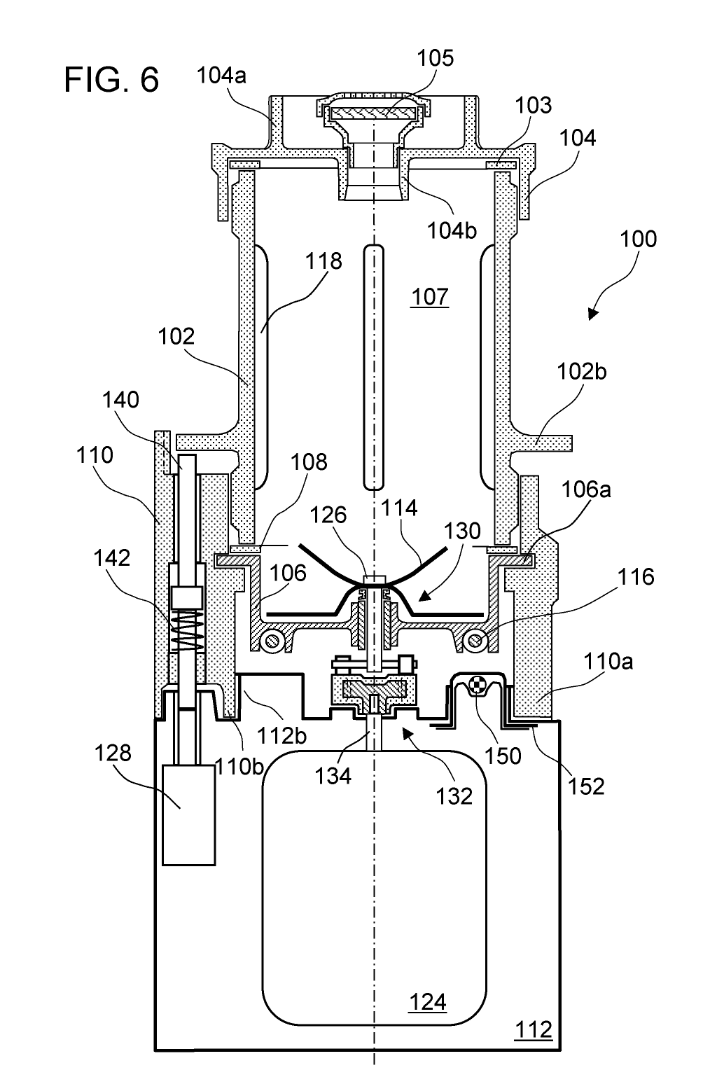

FIG. 6 illustrates another cross-sectional view of blender 100 to better describe how cooking chamber 107 is installed on blender base 112. Position guides 110a and 110b are inserted into base guides 112a and 112b, respectively, such that cooking chamber 107 is removably locked in position on blender base 112, limiting the rotation of cooking chamber 107 with respect to blender base 112.

However, if a user fails to install jar 102 on jar base 110 first before installing jar base 110 onto blender base 112, device 114 and heated bottom 106 would be directly exposed. In the worst scenario, if, all of a sudden, motor 124 or heating tube 116 starts to work, due to an accidental wrong input by the user, the user would be at tremendous risk of injuries. An in-position detector 128 is provided to avoid this worst scenario, for user safety protection. Detector 128 makes sure that only when jar 102 has been installed onto jar base 110 properly, can motor 124 and heating tube 116 be connected to an electrical power.

Detector 128 is installed inside blender base 112 and is activated by an elongated driving member 140, e.g., an elongated rod. Driving member 140 is installed on the side of jar base 110, passing through a channel. A spring mechanism 142 is adapted to bias driving member 140 upward, such that the upper end of driving member 140 protrudes above the upper edge of jar base 110 for a predetermined distance. A circular rim 102b is integrally constructed on the lower portion of jar 102, at a location immediately above the upper edge of jar base 110. Jar 102 is allowed to turn all around with respect to jar base 110, without being obstructed by the upper end of driving member 140. When jar 102 is tightened onto jar base 110, the lower surface of rim 102b pushes against the upper end of driving member 140, such that the lower end of driving member 140 protrudes downward for a predetermined distance. When jar base 110, together with jar 102, is properly installed on blender base 112, the lower end of driving member 140, then, activates detector 128 to confirm that cooking chamber 107 is well positioned and jar 102 has been tightened onto jar base 110.

As shown in FIG. 6, thermal fuse 150 is installed inside a reverse metal cup 152, which is installed on top of blender base 112. The closed end of cup 152 is extended upward into the heating chamber formed by heated bottom 106 and the upper surface of blender base 112. Fuse 150 is preferably disposed at a location substantially close to either heating tube 116 or the bottom of heated bottom 106 to detect and control excessive abnormal temperature rising of the heating chamber.

Accordingly, as cooking chamber 107 is properly installed in position on blender base 112, motor 124 is coupled with device 114, thermostat 122 is engaged with thermo plate 120, or directly with the bottom of heated bottom 106, the electrical terminals of heating tube 116 are operatively connected with electrical port 112c, and detector 128 is activated to confirm that cooking chamber 107 is well in position.

Accordingly, readers will see that this blender of the present invention can be used to cook and/or to blend food to make various healthy foods, cold and/or hot, for examples, baby foods, or creamy soups, or sauces, or gravies, or dips, for children and adults, as well. The tubular design of the jar makes the blender highly convenient for cleaning after use. An attached electrical heating tube is highly efficient in heating food, thereby saving time and energy to consumers. The jar is removably engaged with a jar base, such that the jar can be separated or detached from the heated bottom for cleaning after use. The safety protection device makes sure that only when the jar has been properly installed onto the jar base, can the motor and the heater receive electrical power; which presents a superior safety feature of the present invention.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A blender, said blender comprising:
a jar having an open top and an open bottom for holding food;
a top cap installed on top of said jar for closing up the open top of said jar;
a heated bottom sealingly engaged with the open bottom of said jar for forming a cooking chamber;
blade means extended into said cooking chamber for blending or stirring food;
heating means fixedly installed on the bottom of said heated bottom for heating food disposed inside said cooking chamber;
a blender base disposed underneath said cooking chamber for supporting said cooking chamber;
a motor installed inside said blender base and operatively coupled with said blade means for driving said blade means;
a jar base removably engaged with the lower portion of said jar and engaged with said heated bottom for supporting said cooking chamber and for adapting said cooking chamber to stand on said blender base;
a safety device for user safety protection; and
wherein said safety device is activated by the lower portion of said jar, as said jar is tightened onto said jar base.

2. A blender as defined in claim 1, wherein said jar includes a laterally extended rim for activating said safety device, said laterally extended rim is disposed at the lower portion of said jar, immediately above the upper edge of said jar base, and, as said jar is tightened onto said jar base, the lower surface of said laterally extended rim activates said safety device.

3. A blender as defined in claim 1, wherein said safety device includes:
an in-position detector installed inside said blender base;
an elongated driving member for activating said in-position detector;
a spring member for biasing said elongated driving member upward; and
wherein the upper end of said elongated driving member is removably engaged with the lower portion of said jar, as said jar is tightened onto said jar base.

4. A blender as defined in claim 3, wherein the upper end of said elongated driving member protrudes upward above the upper edge of said jar base for a predetermined distance, as said jar is tightened onto said jar base, a circular rim, which is extended laterally from the lower portion of said jar, immediately above the upper edge of said jar base, pushes against the upper end of said elongated driving member, such that the lower end of said elongated driving member protrudes downward for a predetermined distance, and, as said jar base, together with said jar, is installed onto said blender base, the lower end of said elongated driving member activates said in-position detector.

5. A blender as defined in claim 4, wherein said elongated driving member is an elongated rod member passing through a channel and said channel is disposed at the side of said jar base.

6. A blender as defined in claim 1, wherein an electrical port is installed on top of said blender base for providing electrical power to said heating means, as said cooking chamber is installed in position on said blender base.

7. A blender as defined in claim 1, wherein the lower portion of said jar is engaged with the upper portion of said jar base by means of threading and wherein said jar is removable from said jar base, such that said jar is convenient for cleaning after use.

8. A blender as defined in claim 1, wherein a seal member is installed in between the lower end of said jar and the periphery of said heated bottom for sealing off the interface thereof, and, as said jar is tightened onto said jar base, said seal member is squeezed to form a seal thereof.

9. A blender as defined in claim 1, wherein a thermal fuse is installed inside a metal holder, which is installed on top of said blender base, for limiting the temperature of said heated bottom.

10. A blender as defined in claim 9, wherein said metal holder is a reverse metal cup, the closed end of said reverse metal cup extends upward into the heating chamber formed by said heated bottom and the upper surface of said blender base, and said thermal fuse is disposed substantially close to said heating means or said heated bottom.

11. A blender as defined in claim 1, wherein said heating means includes a heating tube of a circular configuration, said heating tube is fixedly installed on the bottom of said heated bottom, and said heating tube is disposed substantially close to the periphery of the bottom of said heated bottom.

12. A blender as defined in claim 1, wherein a thermostat is directly installed on the bottom of said heated bottom for detecting and limiting the temperature of said heated bottom, such that said heating means and the neighboring components are not overheated.

13. A blender as defined in claim 1, wherein a thermostat is installed on top of said blender base and is biased upward by means of a spring member for detecting and limiting the temperature of said heated bottom, such that said heating means and the neighboring components are not overheated, and, as said cooking chamber is disposed in position on said blender base, said thermostat is adapted to be operatively engaged with the bottom of said heated bottom.

14. A blender as defined in claim 1, wherein said heated bottom includes a sealing device for sealing off the interface between a drive shaft and the bottom of said heated bottom, said sealing device includes a bushing member fixedly and sealingly engaged with a central aperture opened on the bottom of said heated bottom, and said drive shaft is threaded through said bushing member.

15. A blender as defined in claim 1, wherein said jar base includes at least one position guide for guiding said cooking chamber in position on said blender base, said blender base includes at least one base guide for removably receiving said at least one position guide from said jar base, such that said cooking chamber is guided in position on said blender base and the rotation of said cooking chamber with respect to said blender base is limited.

16. A blender as defined in claim 1, wherein a venting device is installed on top of said top cap for venting steam generated during cooking and said venting device includes filter material for filtering the vented steam, or for minimizing food throw-out.

17. A blender as defined in claim 16, wherein said top cap includes a cylindrical inner wall, emanating from the inside of said top cap downward to a predetermined distance for diverting food downward to reduce food throw-out while food is being blended or stirred.

18. A blender, said blender comprising:
a jar having an open top and an open bottom for holding food;
a top cap installed on top of said jar for closing up the open top of said jar;
a heated bottom sealingly engaged with the open bottom of said jar for forming a cooking chamber;
a seal member installed in between the lower end of said jar and the periphery of said heated bottom for sealing off the interface thereof;
blade means extended into said cooking chamber for blending food;
heating means fixedly installed on the bottom of said heated bottom for heating food disposed inside said cooking chamber;
a blender base disposed underneath said cooking chamber for supporting said cooking chamber;
a motor installed inside said blender base and operatively coupled with said blade means for driving said blade means;
a jar base removably engaged with the lower portion of said jar and engaged with said heated bottom for supporting said cooking chamber and for adapting said cooking chamber to stand on said blender base;
an electrical port installed on top of said blender base for providing electrical power to said heating means;
a thermostat communicating with the bottom of said heated bottom for detecting and limiting the temperature of said heated bottom;
a safety device for user safety protection; and
wherein said jar includes a laterally extended rim, disposed at the lower portion of said jar, immediately above the upper edge of said jar base, and, as said jar is tightened onto said jar base, the lower surface of said laterally extended rim activates said safety device.

19. A blender as defined in claim 18, wherein said safety device includes:
an in-position detector installed inside said blender base;
an elongated driving member for activating said in-position detector;
a spring member for biasing said elongated driving member upward; and
wherein the upper end of said elongated driving member is removably engaged with said laterally extended rim, as said jar is tightened onto said jar base.

20. A blender as defined in claim 19, wherein said elongated driving member is an elongated rod member passing through a channel and said channel is disposed at the side of said jar base.
